(19) United States
(12) Patent Application Publication
(10) Pub. No.: US 2002/0055969 A1
(43) Pub. Date: May 9, 2002

(54) Network connection method and removable recording medium

(76) Inventors: Tatsuru Sato, Chiba-shi (JP); Isao Arai, Chiba-shi (JP); Katsuhiko Fuse, Chiba-shi (JP); Yosuke Kanno, Chiba-shi (JP); Ken Mutou, Chiba-shi (JP); Satoshi Tsuchiya, Chiba-shi (JP)

Correspondence Address: ADAMS & WILKS, 31st Floor, 50 Broadway, New York, NY, 10004, US

(21) Appl. No.: 09/945,590

(22) Filed: Sep. 4, 2001

(30) Foreign Application Priority Data
Sep. 5, 2000 (JP) 2000-268977
Sep. 4, 2001 (JP) 2001-266732

(51) Int. Cl. G06F 15/16

(52) U.S. Cl. 709/203

(57) ABSTRACT

There is provided a method of connecting to a network such as the internet, having good operability for a user. When the user sets a medium into a personal computer, a central processing unit of the personal computer reads a booting program, an OS, various applications and a network connection program for connecting to the internet or the like which have been written into a ROM unit and RAM unit of the medium, then boots these and connects to the network such as the internet. Data downloaded from the connecting destination is written to the RAM unit of the medium and used locally.

### BACKGROUND OF THE INVENTION

1. Field of the Invention

The present invention relates to a network connection method and a computer readable removable storage medium for storing a program to make a computer execute the network connection method, which are particularly effective for downloading a specific-purpose data through the internet and managing the data.

2. Description of the Related Art

Generally, a computer readable storage media (i.e., media) is beginning to have greater capacity due to the advance of the recent computer technology. For example, a hard disk which is built in a personal computer (i.e., PC) main body is beginning to be made to store an operating system (i.e., OS), a connection program (i.e., browser) for connecting to the internet and a variety of types of data. Further, the data and the like which has been obtained through a network such as the internet is also generally accumulated on the hard disk.

Accordingly, with the conventional network connection method, reading out each type of program accumulated on the hard disk in order and making the CPU execute these make the connection to the internet or the like possible to accumulate a variety of types of data which was downloaded on the hard disk at that time, thereby displaying the content based on these various data.

However, with the conventional network connection method which is described above, all of the data was recorded on the hard disk which is built in the main body of the PC, thereby causing a problem that the connection status is dependent upon the PC main body, and the user operability, namely, ease of use was poor.

### SUMMARY OF THE INVENTION

The present invention has been made to solve the problems such as those described above, and an object thereof is to provide a network connection method in which the most current contents can be displayed on a screen quickly and by means of simple manipulations while the ease of use for the user is good by making the downloaded data be easily managed.

In order to solve the above problem and achieve the object, a network connection method according to the invention of claim 1 is characterized by comprising: a reading process in which at a time when a removable storage medium having a read-only unit for recording, in read-only format, data such as various types of programs, and a read-capable write-capable unit for reading and writing various types of data, is set in a computer main body in an exchangeable fashion, the data is read from the read-only unit and from the read-capable write-capable unit of the removable storage medium; a booting process of booting a computer based on a program read from the removable storage medium; a network connection process of downloading various types of data through a network, based on the program read out from the removable storage medium; and a writing process of writing to the read-capable write-capable unit the various types of data downloaded through the network.

Further, a network connection method according to the invention of claim 2, in a network connection method according to claim 1, is characterized by comprising: an update determination process of determining whether or not the various types of downloaded data is update data having updated the various types of data already recorded in the read-capable write-capable unit; and an updating process of updating the recorded data to the various types of downloaded data in the case where the downloaded data is update data.

Further, a network connection method according to the invention of claim 2, in a network connection method according to claim 1, is characterized by comprising a displaying process of using data read out from the read-only unit and the read-capable write-capable unit of the removable storage unit in order to display various content before the execution of the network connection process, and also, using various downloaded content in order to display various content after the execution of the network connection method.

Further, a network connection method according to the invention of claim 4, in a network connection method according to claim 1, is characterized by comprising an executing process of executing a program after the execution of the network connection process in the case where the various downloaded data is the program.

Further, a network connection method according to the invention of claim 5, in a network connection method according to claim 1, is characterized by comprising a booting information comparison process of comparing booting information stored in an auxiliary storage medium provided separately from the removable storage medium, and booting information stored in the removable storage medium; wherein as a result of the comparison conducted in the booting information comparison process, the booting process is performed based on the booting information recorded in the auxiliary storage medium in the case where the two sets of booting information is identical.

Further, a network connection method according to the invention of claim 6, in a network connection method according to claim 5, is characterized in that, as a result of the comparison conducted in the booting information comparison process, the booting process is performed based on the booting information recorded in the removable storage medium in the case where the two sets of booting information are mutually different.

Further, in a network connection method according to the invention of claim 7, in a network connection method according to claim 1, is characterized by comprising a booting information confirmation process for confirming that booting information is recorded in the removable storage medium; wherein as a result of the comparison conducted in the booting information confirmation process, the booting process is performed based on the booting information recorded in the auxiliary storage medium in the case where booting information is not recorded in the removable storage medium.

Further, a network connection method according to the invention of claim 8, in a network connection method according to claim 1, is characterized by comprising a temporary recording process of temporarily recording the various data recorded in the removable storage medium into the auxiliary storage medium provided separately from the removable storage medium; and a forward-and-record process for forwarding and recording the various information temporarily recorded in the auxiliary storage medium over to a separate removable storage medium.

Further, a network connection method according to the invention of claim 9, in a network connection method according to claim 11, is characterized by comprising a disconnecting process of disconnecting the connection to the network after completion of the downloading of the various data in the network connection process.

Further, a network connection method according to the invention of claim 10, in a network connection method according to claim 1, is characterized in that the program execution process to be performed after the execution of the network connection process further comprises: a connection information saving process of recording connection information to the read-capable write-capable unit of the removable storage medium or to the auxiliary storage medium; a disconnection process of disconnecting the connection to the network after completion of the connection information saving process; and a network reconnection process of reconnecting to the network in the same state as that before the disconnection process according to the connection information saved in the connection information saving process after the completion of the program execution process.

Further, a network connection method according to the invention of claim 11, in a network connection method according to claim 10, is characterized in that an application executed in the program execution process is an application using a telephone line.

Further, a network connection method according to the invention of claim 12, in a network connection method according to claim 1, is characterized in that the network is internet, and the network connection method connects to a server having the data to be downloaded via the internet.

Further, a network connection method according to the invention of claim 13, in a network connection method according to claim 12, is characterized in that the various data recorded in the removable storage medium and data of a server are data which are established as a pair by means of data correspondence information stored in the removable storage medium, and the data correspondence information is uploaded in the network connection process, producing a result that the various data being stored in the removable storage medium are linked to the data of the server.

Further, a computer readable removable storage medium according to the invention of claim 14 is characterized by having a read-only unit for recording, in read-only format, data such as various types of programs, and a read-capable write-capable unit for reading and writing the various types of data, and also, is set in a computer main body in an exchangeable fashion, and stores a program in its read-only unit for making a computer execute a network connection method comprising: a booting process of booting the computer; a network connection process of downloading various types of data through a network; and a writing process of writing to the read-capable write-capable unit the various types of data downloaded through the network. Owing to the above, the network connection method can be realized by utilizing a computer.

Further, a computer readable removable storage medium according to the invention of claim 15, in a computer readable removable storage medium according to claim 14, is characterized in that the read-only unit is made of a physical or electrical means for being read only, and the read-capable write-capable unit is made of a physical or electric means capable of being read and written to.

Further, a computer readable removable storage medium according to the invention of claim 16, in a computer readable removable storage medium according to claim 14, is characterized in that at a time when the computer is booted by means of the stored booting information, the read-only unit is defined as an area for being read from only.

Note that it is also possible to execute the network connection process immediately after completion of the booting process, for example. Further, it is also possible to execute the network connection process at regular intervals of a predetermined amount of time. Further, the network connection process may also be executed in the case where the data in the removable storage medium is insufficient. Further, the network connection process may also include a local operation process to be operated locally after the completion of the booting process, with the network connection process being performed at a time when a command to connect to the network is made during the local operation process.

Further, the network connection process may also be executed at a time when a request from update data is designated inside the removable storage medium. Further, the network connection process may be executed at a time when connecting a link destination which has not been written into the removable storage medium. Further, the network connection process may be executed after a given duration of time elapses after the writing of the data into the removable storage medium. In this case, it is desirable for the data to be downloaded from the removable storage medium during the interval from the time when the data is written to the removable storage medium until before the given constant duration of time elapses.

### BRIEF DESCRIPTION OF THE DRAWINGS

In the accompanying drawings:

FIG. 1 is a diagram of a construction of a system for realizing a network connection method according to an embodiment;

FIG. 2 is a block diagram depicting a functional construction of hardware for realizing the network connection method according to the embodiment of the present invention;

FIG. 3A to FIG. 3C are conceptual diagrams of media for realizing the network connection method according to the embodiment of the present invention;

FIG. 4 is a block diagram depicting a specific example of the functional construction of the hardware for realizing the network connection method according to the embodiment of the present invention;

FIG. 5 is a flow chart depicting a process of connecting to a network;

FIG. 6 is a flow chart depicting a process of connecting to a network; and

FIG. 7 is a flow chart depicting a process of connecting to a network.

### DETAILED DESCRIPTION OF THE PREFERRED EMBODIMENTS

Hereinafter, detailed explanation will be made of a network connection method according to a preferred embodiment of the present invention with reference to the attached drawings. Note that the present invention is not limited to the embodiment.

(System construction)

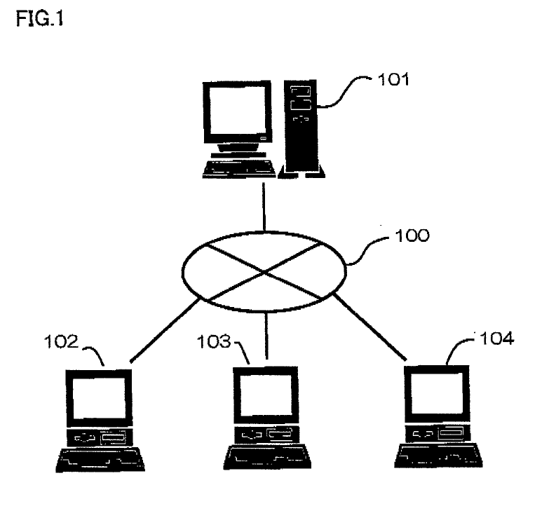

FIG. 1 is a diagram of a construction of a system for realizing a network connection method according to an embodiment. In FIG. 1, the system for realizing the network connection according to the present embodiment is comprised of a server 101 and terminal devices 102, 103, 104, etc., all of which are each connected to a network 100 such as the internet. The server 101 and the terminal devices 102, 103, 104, etc. are realized by a computer such as a personal computer including a portable-type computer, workstation, or the like capable of reading from and writing to removable storage media.

Note that the removable storage medium (hereinafter referred to as “media”) are media which are easily removed from the computer main body, and have a read-only unit (sometimes indicated as a ROM unit) and a read-capable and write-capable unit (sometimes indicated as a RAM unit), as described below. These media include, for example, disk-form media such as CD−RW, DVD−RAM, DVD−RW and DVD+RW, and memory media such as flash memory, compact flash, smart media, memory sticks and SD cards.

(Functional construction)

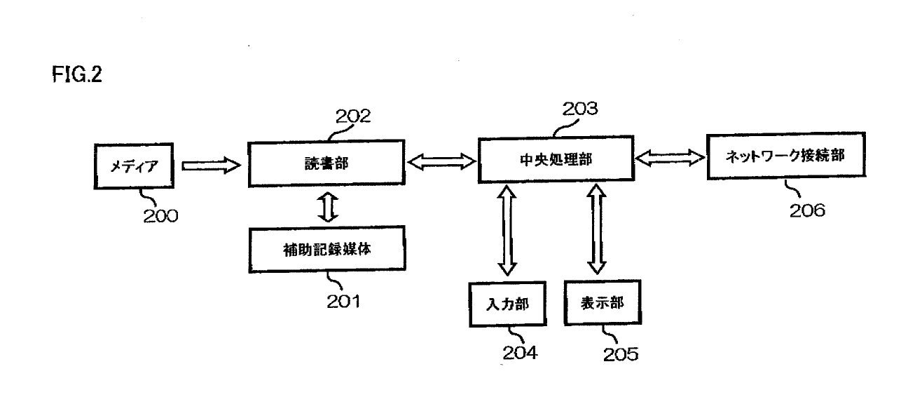

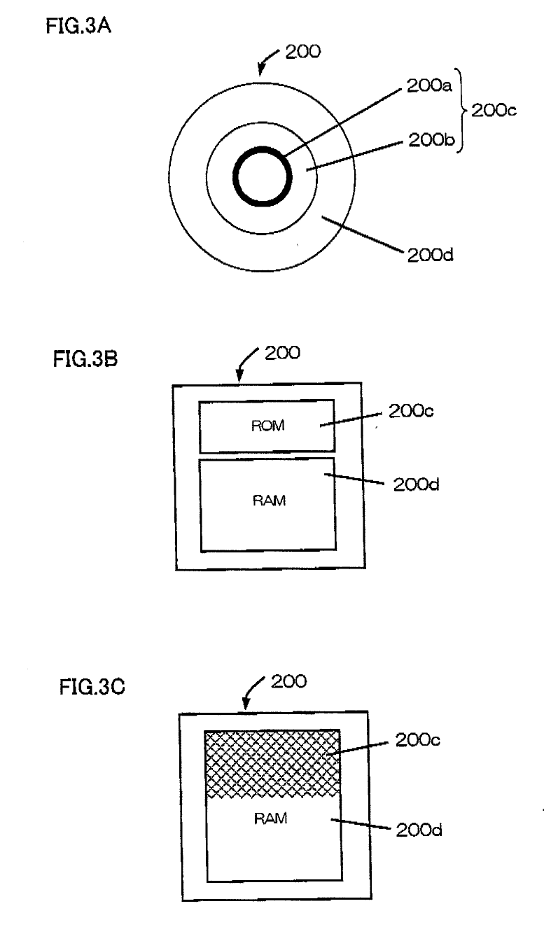

Next, explanation will be made of a functional construction of hardware for realizing the network connection method according to the embodiment of the present invention. FIG. 2 is a block diagram depicting a functional construction of hardware for realizing the network connection method according to this embodiment of the present invention. FIG. 3A to FIG. 3C are conceptual diagrams of media for realizing the network connection method according to this embodiment of the present invention.

In FIG. 2, reference numeral 200 indicates a medium, 201 indicates an auxiliary storage medium, 202 indicates a reading and writing unit (hereinafter abbreviated as “read-write unit), 203 indicates a central processing unit, 204 indicates an input unit, 205 indicates a display unit and 206 indicates a network connection unit.

The medium 200 has a read-only unit 200c composed of a booting unit 200a and a fixed data unit 200b, and a read-capable write-capable unit 200d. In the booting unit 200a, there is recorded program data having a mechanism for booting basic software such as an operating system (i.e., OS), which is booted from a boot software such as a boot program or kernel which is read at the time of booting at the very beginning. In the fixed data unit 200b, there is recorded each type of application program which is dependent upon the method in which the invention is to be used, and fixed data which is dependent upon the method of use. The read-only unit 200c is only for reading, and is configured so as not to be able to perform a write-over. The read-capable write-capable unit 200d is configured so as to be able to perform both reading and writing.

The basic software recorded in the booting unit 200a is the operating system (OS), various types of drivers and the like. These drivers include, for example, a driver for a user interface for inputting and outputting, and a driver for reading and writing the medium 200 itself. The various types of applications stored in the fixed data unit 200b are drivers for communication such as a dial-up program or the like, and programs for the network connection which include communications protocols, data of the portal site content and various non-changing data. The data recorded in the read-capable write-capable unit 200d is a variety of newly added data such as the new parts of upgrades of various programs recorded in the fixed data unit 200b, upgraded contents data, user data and the like.

Note that the data written into the read-only unit 200c is written in by performing a press at the stage when a medium 200 such as the CD−RW is manufactured, so this data can be written to the medium 200 easily and efficiently even if it has great volume.

Returning to FIG. 2, the auxiliary storage medium 201, as explained below, records a temporary record for the exchanges of data among a plurality of the media 200, and other varieties of data. The read-write unit 202 performs reading and writing to and from the medium 200 and the auxiliary storage medium 201. In particular, this read-write unit 202 reads programs or data written onto the read-only unit 200c and the read-capable write-capable unit 200d.

FIGS. 3A to 3C is a diagram for explaining the concept of the medium 200 for realizing the network connection method according to the embodiment of the present invention; FIG. 3A depicts the case of a disk medium, and FIGS. 3B to 3C depict the case of a memory medium.

On the disk-form medium 200 of FIG. 3A, there are arranged the read-only unit 200c and the read-capable write-capable unit 200d; and the read-write unit 202 reads the program or data written on the read-only unit 200c and the read-capable write-capable unit 200d.

On the medium 200 of FIG. 3B using a memory element, there are arranged the read-only unit 200c composed of a ROM (i.e., read only memory) element, and the read-capable write-capable unit 200d composed of a RAM (i.e., random access memory) element.

The medium 200 of FIG. 3C using a memory element is composed of a RAM (random access memory) element, and after basic software such as the operating system (OS) is booted, a specific area within the element is defined as the read-only unit 200c, and the other area functions as the read-capable write-capable unit 200d.

Further, the read-write unit 202 writes update information and other various data received through the network connection unit 206 onto the read-capable write-capable unit 200d of the medium 200. In this way, information which change on a daily basis such as the contents data are downloaded from the server 101 when the connection is made to the network 100 such as the internet, and written to the read-capable write-capable unit 200d.

In other words, information which has large volume, such as images and the like which require much time to download, and which do not need to be updated frequently are written to the read-only unit 200c, and data which is updated daily goes into the read-capable write-capable unit 200d and the content thereof is updated through the network 100 such as the internet.

The central processing unit 203 governs the overall processing. In particular, this central processing unit 203, as described below, executes the various programs read out from the medium 200 for executing functions of the various processes, and it is connected to the network 100 such as the internet. The input unit 204 is a mouse or other such pointing device, or a keyboard or other such input device. The display unit 205 is a CRT (Cathode Ray Tube), or liquid crystal or other such display. In particular, various content screens are displayed on the display unit 205 based on the various data written into the read-only unit 200c and the read-capable write-capable unit 200d of the medium 200.

The network connection unit 206 obeys the network connection program executed by the central processing unit 203, and connects to the server 101 through the network 100 such as the internet (see FIG. 1). Then, this network connection unit 206 receives from the server 101 various content data and other such updated information and newly added information, through the network 100. Additionally, this network connection unit 206 sends various data to the server 101.

Note that the connection of the network connection unit 206 to the network 100 is severed, as necessary, after the various data are received. Accordingly, while the various content is being displayed and the user is being let to perform various processing on this content, the connection to the network 100 is not maintained, so it is possible to save connection fees (communications fees). Further, the central processing unit 202 can also print the various contents being displayed on the display unit 205 by means of a printer which is not depicted in the diagram.

Further, due to the operations of the program, connection information is temporarily recorded on the auxiliary storage medium 201 at the time when the connection to the network 100 is severed, and when the connection to the network 100 becomes necessary again, this connection information is used to make the connection, which produces the result that the user is not made to be conscious of the changes of the connected and non-connected states to the network, making possible a seamless network connection.

In addition, in the case where common telephone lines are used to make the connection to the network 100 using point-to-point control (i.e., PPP) or the like, the telephone lines may become congested during the network connection and general voice telephone communication may become impossible; however, it is possible for the program to dial a voice telephone when the disconnection to the network occurs, and then after the communication ends, it is possible to make the reconnection to the network using the connection information that was saved when the disconnection occurred. Therefore, it is possible to achieve a seamless network connection in which the user is not made to be conscious of the changes between the states of being connected to and disconnected from the network, including even the use of the voice telephone as a means of the communication.

In the above-described construction, when the medium 200 is set by the user into a drive, the drive reads out various programs and other such data from the read-only unit 200c or the read-capable write-capable unit 200d of the medium 200. Then, the central processing unit 203 executes the various programs which have been read out. In the case where the data of various contents has been stored in advance, this content is displayed based on this data. Note that in the case where there does not exist any data to be displayed, the data for the various content is downloaded through the network 100 and outputted to the display unit 205 and made to be displayed. At this point, the central processing unit 203 writes the downloaded various content data onto the read-capable write-capable unit 200d of the medium 200, and the next time this data is to be displayed, it is read out and then displayed.

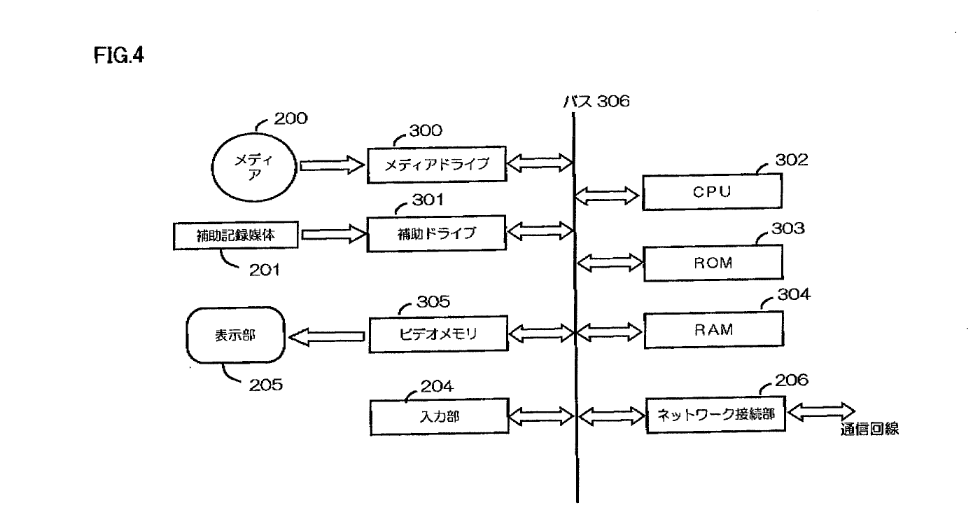

Next, explanation will be made of a particular example of a functional construction of hardware for realizing the network connection method according to the present embodiment of the invention. FIG. 4 is a block diagram depicting the specific example of the functional construction of the hardware for realizing the network connection method according to this embodiment of the present invention. Note that the same reference numerals are applied to the construction that is identical to the construction of FIG. 2 above.

In FIG. 4, a media drive 300 and an auxiliary drive 301 realize the function of the read-write unit 202. The media drive 300 reads out the various data from the read-only unit 200c and the read-capable write-capable unit 200d of the medium 200, and also, performs reading and writing of data to and from the read-capable write-capable unit 200d. The auxiliary drive 301 performs reading and writing of data to and from the auxiliary storage medium 201.

Further, a CPU 302, a ROM 303 and a RAM 304 realize the function of the central processing unit 203. The CPU 302 executes, in order, various programs which have read out various data from the ROM 303 and the RAM 304. In the ROM 303, there is stored a program particularly for reading the booting unit 200a of the medium 200. The RAM 304 stores the various programs and other such data which have been read from the read-only unit 200c and the read-capable write-capable unit 200d of the medium 200.

Further, a video memory 305 holds display area data corresponding to the screen of the display unit 205. To a bus 306, there are connected the media drive 300, the auxiliary drive 301, the CPU 302, the ROM 303, the RAM 304, the video memory 305, the input unit 204 and the network connection unit 206, respectively.

(Network connection sequence)

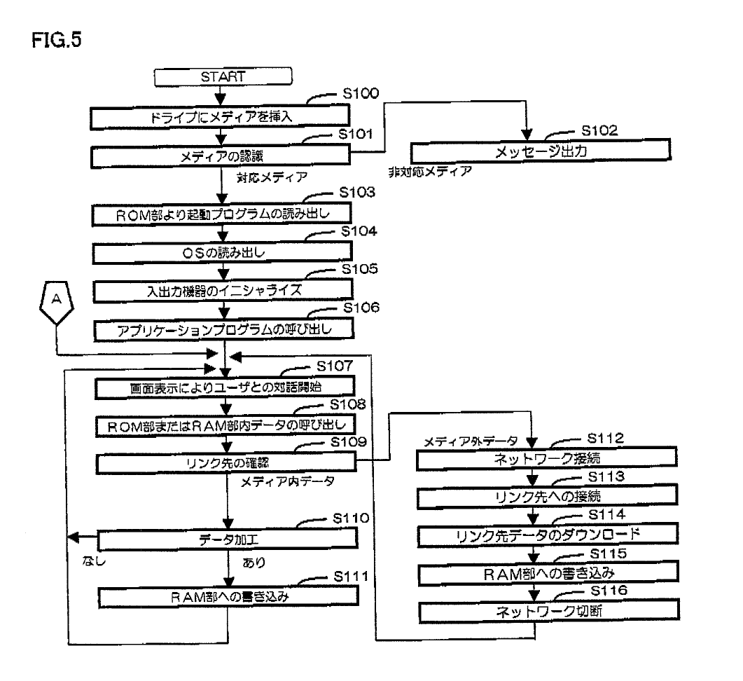

Next, an explanation will be made of a network connection sequence, according to the present embodiment. FIG. 5 is a flow chart depicting the sequence of connecting to the network. In the flow chart of FIG. 5, first, when the user sets the medium 200 into the personal computer (i.e., PC), which is a terminal device 102 (103, 104) (step S100), the central processing unit 203 recognizes the medium 200 which has thus been set in (step S101), and when the recognition of the medium 200 produces a determination that the medium 200 is a non-corresponding medium, the procedure transits to S102, and in the case where the medium 200 is determined to be a corresponding medium, the procedure transits to S103.

Then, the central processing unit 203 displays a message on the display unit 205 indicating that the medium 200 is non-corresponding, and then the processing ends (step S102). On the other hand, in the case where the medium is corresponding, the central processing unit 203 first reads the booting program which has been written into the booting unit 200a of the read-only unit 200c (step S103) and boots the terminal device 102 (103, 104). Then, the central processing unit 203 reads the OS from the fixed data unit 200b of the read-only unit 200c (step S104) and boots the OS. Next, the central processing unit 203 performs initialization of input instruments such as the input unit 204 and the display unit B205 (step S105), calls up the various application programs from the fixed data unit 200b or the read-capable write-capable unit 200d of the read-only unit 200c (step S106) and begins execution.

Accordingly, the central processing unit 203 begins a dialogue with the user by means of the screen display (step S107). At this point, when the user gives a command to display data that has been downloaded, for example, and a command is given to display this downloaded data, the central processing unit 203 calls up the data inside the read-only unit 200c or the read-capable write-capable unit 200d (step S108), and confirms the link destination of the designated data (step S109). Then, in the case where the designated link destination is data inside the medium, the central processing unit 203 moves the processing to step S110, and in the case where the link destination is data outside the medium, the central processing unit 203 moves the processing to step S112.

Confirmation is made as to whether the data for which the display command has been given has undergone any processing or not (step S110). For example, in the case where the downloaded data is renewed data that has already been stored in the read-only unit 200c or the read-capable write-capable unit 200d, this downloaded data is written to the read-capable write-capable unit 200d as update data (step S111). Note that in the case where no processing has been performed whatsoever, the display or the like is performed and the process returns to the step S107.

On the other hand, in the case where, at step S109, the link destination is recognized as being outside of the medium, the network connection program being stored inside the read-only unit 200c is booted and the connection to the network 100 such as the internet is made (step S112). Then, a connection is made to the designated link destination (step S113), and the data at the link destination is downloaded (step S114). At this point, the central processing unit 203 writes the downloaded data to the read-capable write-capable unit 200d (step S115), displays the content and the like containing the downloaded updated data onto the display unit 205, and disconnects the connection to the network 100 (step S116). Note that a configuration is also possible in which, at this point, the disconnection from the network 100 is made by a command from the user as needed, or automatically by a program set in advance.

Therefore, merely by setting the medium 200, it is possible to screen display the most current content data. Moreover, if the connection to the network is made to be disconnected automatically after completion of the downloading of the updated data and the like, then it is possible to perform this without monopolizing the telephone lines. Further, unnecessary charges are not incurred, and the user can read the content at a leisurely pace and with peace of mind.

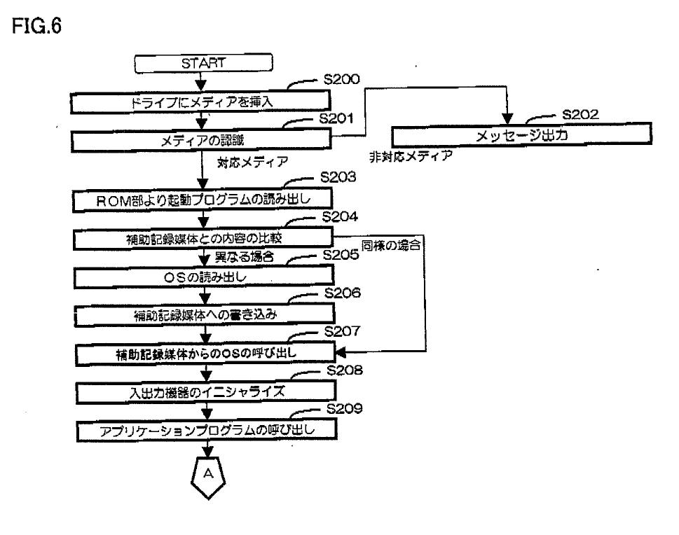

Next, an explanation will be made of a case in which the auxiliary storage medium 201 is used and booted. FIG. 6 is a flowchart depicting a sequence of connecting to a network. In the flow chart of FIG. 6, first, when the user sets the medium 200 into the personal computer (i.e., PC), which is a terminal device 102 (103, 104) (step S200), the central processing unit 203 recognizes the medium 200 which has thus been set (step S201). In the case where, as a result of the recognition, the central processing unit 203 determines that the medium 200 is a non-corresponding medium, the processing transits to S202, and in the case where the medium 200 is determined to be a corresponding medium, the processing transits to S203.

Then, the central processing unit 203 displays a message on the display unit 205 indicating that the medium 200 is non-corresponding, and then the processing ends (step S202). On the other hand, in the case where the medium is corresponding, the central processing unit 203 first reads the booting program which has been written into the booting unit 200a of the read-only unit 200c (step S203) and boots the terminal device 102 (103, 104). Then, the central processing unit 203 reads the data from the read-only unit 200c or the read-capable write-capable unit 200d, and also from the auxiliary storage medium 201, and compares these two (step S204).

In the case where the comparison indicates that the content of these two are different from each other, the central processing unit 203 moves the processing to step S205, and in the case where the content is the same, it moves the processing to step S207. Then, in the case where the two are different from each other, the central processing unit 203 reads the OS from the fixed data unit 200b of the read-only unit 200c (step S205), and writes this OS to the auxiliary storage medium 201 (step S206). Further, in the case where the two are the same, the central processing unit 203 reads out from the auxiliary storage medium 201 the OS that was written at the step S206 above (step S207), and boots the OS.

Next, the central processing unit 203 performs initialization of input instruments such as the input unit 204 and the display unit 205 (step S208), calls up the various applications from the fixed data unit 200b or the read-capable write-capable unit 200d of the read-only unit 200c (step S209) and begins execution thereof. Hereinafter, the processing is the same as that of step S107.

Accordingly, in the case where the OS is identical, the OS is executed form the auxiliary storage medium 201, so in the case where the medium 200 is a CD—RW, it is preferable that the auxiliary storage medium 201 is a SRAM, DRAM or some other technology which has a shorter access time, whereby the boot time for the terminal device 102 (103, 104) can be made to be shorter.

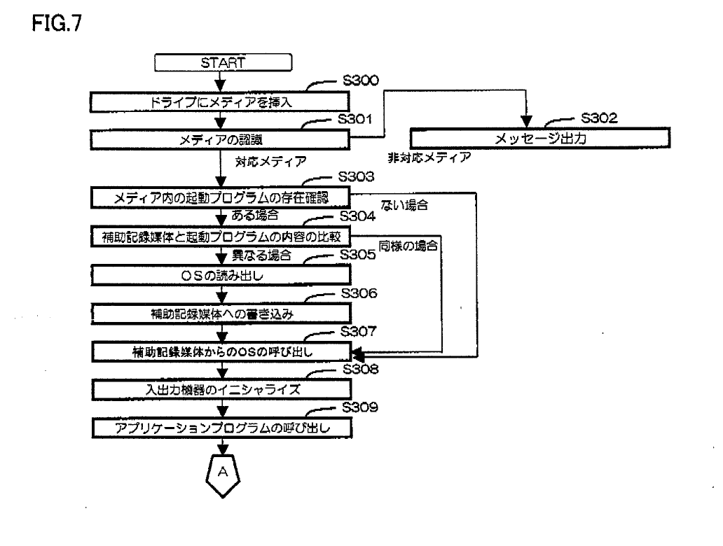

Next, an explanation will be made of another case in which the auxiliary storage medium 201 is used and booted. FIG. 7 is a flow chart depicting a sequence of connecting to a network. In the flow chart of FIG. 7, first, when the user sets the medium 200 into the personal computer (i.e., PC), which is a terminal device 102 (103, 104) (step S300), the central processing unit 203 recognizes the medium 200 which has thus been set in step S300). In the case where, as a result of the recognition, the central processing unit 203 determines that the medium 200 is a non-corresponding medium, the processing transits to S302, and in the case where the medium 200 is determined to be a corresponding medium, the processing transits to S303.

Then, the central processing unit 203 displays a message on the display unit 205 indicating that the medium 200 is non-corresponding, and then the processing ends (step S302). On the other hand, in the case where the medium is corresponding, the central processing unit 203 first verifies the existence of the booting program which has been written into the booting unit 200a of the read-only unit 200c (step S303).

Here, in the case where the boot program has not been written to the booting unit 200a of the read-only unit 200c, the central processing unit 203 boots the terminal device 102 (103, 104), and after that, moves the processing to step S207.

In the case where the booting program has been written into the booting unit 200a of the read-only unit 200c, the central processing unit 203 boots the terminal device 102 (103, 104), and after that, reads the data in either the read-only unit 200c or the read-capable write-capable unit 200d, and in the auxiliary storage medium 201, and compares these two (step S304).

In the case where the comparison indicates that the contents of these two are different from each other, the central processing unit 203 moves the processing to step S305, and in the case where the contents are the same, it moves the processing to step S307. Then, in the case where the two are different from each other, the central processing unit 203 reads the OS from the fixed data unit 200b of the read-only unit 200c (step S305), and writes this OS to the auxiliary storage medium 201 (step S306). Further, in the case where the two are the same, the central processing unit 203 reads out from the auxiliary storage medium 201 the OS that was written at the step S206 above (step S307), and boots the OS.

Next, the central processing unit 203 performs initialization of input instruments such as the input unit 204 and the display unit 205 (step S308), calls up the various applications from the fixed data unit 200b or the read-capable write-capable unit 200d of the read-only unit 200c (step S309) and begins execution thereof. Hereinafter, the processing is the same as that of step S107.

Accordingly, even in the case of a corresponding medium in which the booting information does not exist, it is still possible for the OS to be executed from the auxiliary storage medium 201.

Note that using the auxiliary storage medium 201 makes it possible to copy the content from one medium 200 to another medium 200. That is, the central processing unit 203 temporarily records the various data that are recorded in the one medium 200 into the auxiliary storage medium 201, and after that, records the various data that are temporarily recorded in the auxiliary storage medium 201 into the other medium 200, whereby it is possible to prepare the identical network connection environment among a plurality of media 200.

(Specific example of the network connection and specific information recorded in the media)

Lastly, an explanation of the connection to the network 100 such as the internet, using the read-only unit (i.e., area) 200c of the medium 200, the content of specific information of the read-capable write-capable unit (i.e., area) 200d and the medium 200, will be described with a specific example. Note that the explanation of the types of the data recorded in the read-only unit 200c is provided in view of application programs and fixed data.

(1) In the case where the connection is made to the internet using the media 200 in order to display the content, the applications programs which are to be recorded into the read-only unit 200c may include a browser, and the fixed data may include data of a portal home page, data of a collection of links to sites amassed according to specific criteria and the like. Further, among the various data to be stored in the read-capable write-capable unit 200d, there are data newly prepared by the user (i.e., user data), data obtained through the communications lines, data for a version upgrade for applications programs etc., (i.e., different or new portions of the programs) and data that has been recorded as the result of communications, for example. Note that it is preferable that the display and the like can be performed locally even in the case where the connection to the network 100 such as the internet is cut off after these various kinds of data are written into the read-capable write-capable unit 200d.

On the other hand, the circumstances under which the communication is to be performed may include, for example, 1) the case when the user selects a link destination; 2) the case when the connection is made to the link destination after a specified duration of time has elapsed; and 3) the case where mutual exchange between or among connection points takes place. Note that in any of these cases, the received various data displayed by the central processing unit 203 together with the various data received by the display unit 205, and also, are stored in the read-capable write-capable unit 200d of the medium 200 by the read-write unit 202. Further, once the various data have been stored in the read-capable write-capable unit 200d, they can be displayed any number of times in the state of being disconnected from the link destination.

In case 1 in which the user has selected a link destination, the central processing unit 203 displays on the display unit 205 the address data of the link destination and the like being stored in the read-only unit 200c or in the read-capable write-capable unit 200d. Then, when the user selects a link destination by performing a click or the like, the central processing unit 203 begins communications via the network connection unit 206, connects to the link destination and receives the content data and other such various data.

In case 2 in which the connection is made to the link destination after the specified duration of time has elapsed, the central processing unit 203 determines that the data stored in the read-capable write-capable unit 200d is already old once a given duration of time passes from the day when this data was previously downloaded, and in the case where a designation is made for the data to be updated at given intervals, communication is opened through the network 100, the connection is made to the link destination of the address being stored in the read-only unit 200c or the read-capable write-capable unit 200d and the content data and other various data are received. Note that the case in which the data is updated at regular intervals refers to a case in which, for example, an electronic mail is sent and received.

In case 3 in which the mutual exchange between or among connection points takes place, the central processing unit 203 displays the address of the link destination and other such data being stored in the read-only unit 200c or the read-capable write-capable unit 200d. Then, in the case where the link destination performs mutual exchanges with data on the network 100 such as a system for making reservations or an auction or the like while operating, the central processing unit 203 opens communications via the network connection unit 206, connects to the link destination and sends and receives the content data and other such various data.

(2) In the case where the connection is made to the internet as necessary using the medium 200 as travel information, or a travel album, the application programs stored in the read-only unit 200c may include a browser, an editing software or the like, and the fixed data may include data of a portal home page and a travel, for example. Further, among the various data to be stored in the read-capable write-capable unit 200d, there are data newly prepared by the user (i.e., user data, including personal information), data obtained through the communications lines, data for aversion upgrade for applications programs etc. (i.e., different or new portions of the programs), data that has been recorded as the result of communications, and one's own travel plan data, for example. Note that it is preferable that the display and the like can be performed locally even in the case where the connection to the internet or other such network 100 is cut off after these various kinds of data are written into the read-capable write-capable unit 200d.

On the other hand, the circumstances under which the communication is to be performed may include, for example, 1) the case where seasonal information such as changes in current hotel fees, seasonal foods and menus or the like, or when more detailed information is obtained; 2) the case where connection is made to a system for verifying the status as to whether seats or the like are available are not and making a reservation for the seat or the like; and 3) the case where access is made to information having value as real-time information, such as the scenery of a place at that moment (ex, such as the way a sunset looks at that time). Note that in any of these cases the received various data is displayed by the central processing unit 203 together with the various data received by the display unit 205, and also, are stored in the read-capable write-capable unit 200d of the medium 200 by the read-write unit 202. Further, once the various data have been stored in the read-capable write-capable unit 200d, they can be displayed any number of times in the state of being disconnected from the link destination.

(3) In the case where the connection is made to the internet as necessary using the medium 200 for management of housing information or housing facilities, the application programs stored in the read-only unit 200c may include a browser, a data management software, a simulation software and the like, and the fixed data may include data of a portal home page and housing-related information, for example. Further, the various data to be stored in the read-capable write-capable unit 200d may include data of properties which satisfy the user's desired criteria, purchase plan, funding plan, or the like. Note that updated housing-related information and the like may be written into the read-capable write-capable unit 200d by means of connecting to the network 100 such as the internet and then displayed. Further, it is preferable that the display and the like can be performed locally even in the case where the connection to the network 100 such as the internet is cut off after this writing process takes place.

On the other hand, the circumstances under which the communication is to be performed may include the case in which, for example, there is valuable information that changes as the hours go by, such as housing information for that given day or other updated housing information, or simulations of finance planning. Note that, in any of these cases, the received various data is displayed by the central processing unit 203 together with the various data received by the display unit 205, and also, are stored in the read-capable write-capable unit 200d of the medium 200 by the read-write unit 202. Further, once the various data have been stored in the read-capable write-capable unit 200d, they can be displayed any number of times in the state of being disconnected from the link destination.

(4) In the case where the connection is made to the internet as necessary using the medium 200 as a mail order catalogue, the application programs stored in the read-only unit 200c may include a browser, an editing software and the like, and the fixed data may include data of a portal home page and catalog merchandise, for example. Further, the various data to be stored in the read-capable write-capable unit 200d may be purchase order data or the like. Note that it is sufficient for more detailed data on merchandise and data on sales and the like to be downloaded by connecting to the network 100 such as the internet, whereby it is written into the read-capable write-capable unit 200d, and then displayed. Further, the display and the like can be performed locally even in the case where the connection to the network 100 such as the internet is cut off after this writing process takes place.

On the other hand, the circumstances under which the communication is to be performed may include the case in which information which changes daily, such as that day's bargain sale merchandise, data on new merchandise, and new information such as the annulment of data on discount goods is necessary, or the case in which communication with another party such as input on purchase data is necessary.

Note that the received various data displayed by the central processing unit 203 on display unit 205, and also, are stored in the read-capable write-capable unit 200d of the medium 200 by the read-write unit 202. Further, once the various data have been stored in the read-capable write-capable unit 200d, they can be displayed any number of times in the state of being disconnected from the link destination.

(5) In the case where the medium 200 is used as an educational system and the connection to the internet is made as necessary in connection with these purposes, the application programs stored in the read-only unit 200c may be a browser and learning management software and the like, and the fixed data may be a portal home page data, a learning environment and test answers, for example. Further, the various data to be stored in the read-capable write-capable unit 200d may be learning programs corresponding to selected criteria, records of submitted answers, distribution of corrections or the like. Note that it is preferable that new learning programs and the like be downloaded by connecting to the network 100 such as the internet, whereby it is written into the read-capable write-capable unit 200d in order to update.

On the other hand, the circumstances under which the communication is to be performed may include, for example, the case when information that a condition for the communication is the delivery of an appropriate learning program has been received, such as in the case where the user's circumstances have changed, when test results or review steps are needed, for example, and it is necessary to provide different information; or the case in which communication is necessary, such as for sending test results or receiving corrections. Note that the various data that is received is displayed by the central processing unit 203 on display unit 205, and also, are stored in the read-capable write-capable unit 200d of the medium 200 by the read-write unit 202. Further, once the various data have been saved to the read-capable write-capable unit 200d, they can be displayed however many number of times in the state of being disconnected from the link destination.

(6) In the case where the medium 200 is to be made to function as a dictionary, a network connection program and/or dictionary search program or other such application programs and fixed data such as the basic data of the dictionary are stored in the read-only unit 200c. Further, explanatory data for the new concepts for new words, for example, is downloaded through the network 100 such as the internet, added to the read-capable write-capable unit 200d, and stored therein. Accordingly, it is possible for the user to purchase dictionaries of new words sold each year and use these dictionaries.

(7) In the case where the medium 200 is to be made to function as for photograph or illustrations management, an application program such as an image handling tool or editing software, and fixed data such as frames for mounting the photographs or commercially sold photographs or image data of illustrations are stored in the read-only unit 200c. Further, the data of the frames in which photographs have been mounted, photographs taken by the user, design data of frames which have been decorated, or the like are recorded in the read-capable write-capable unit 200d.

Note that the album data and the like are downloaded through the network 100 such as the internet and stored, whereby it becomes possible for the user to purchase designs made from the commercially sold frames, for example, and use these. Further, at such times as when the user wants to show to people the photographs which the user took, the image data of the photographs or illustrations can be converted since they have been downloaded through the network 100 such as the internet and stored. Further, in cases wherein it will certainly be necessary to hand the image data over to another person, as in the case of a photograph printing service, the image data can be uploaded through the network 100 such as the internet, whereby it becomes possible to deliver the image data.

As explained above, according to the present embodiment, by performing the simple manipulation of setting the medium, it becomes possible quickly to display the latest content on the screen and execute a variety of types of applications, and also possible to record downloaded data on the medium, whereby the management becomes easy and the usability becomes better for the user.

For example, in the present embodiment, a single user who uses a plurality of PCs can use one PC to connect to the internet and recreate the same status on another PC. Further, according to this embodiment, in the case where a plurality of people share a single PC, each person does not have to leave the state of his or her connection on the PC but can record that state on the medium each time, whereby security can be achieved, and also, that the connection status from the previous time can be used the next time, too.

Further, according to the present embodiment, in the case where many people use different PCs, it is possible for each to have the same status on their respective PCs. Further, according to the present embodiment, in the case where the data volume of the content is great, only that data which does not change much is stored in the read-capable write-capable unit, and only that data which has changed is downloaded, whereby the download time becomes short, and it is possible to reduce the amount of time required to display the content. Further, according to the present embodiment, it is possible to boot the applications separately from the connection to the network, and the data which has already been stored can be displayed as data like a portal.

Further, according to the present embodiment, the disconnection from and the reconnection to the network can be performed automatically, thereby making possible a seamless connection in which the user is not made to be conscious of the disconnection and connection.

Additionally, according to the present embodiment, while being disconnected from the network, the telephone line which was being used for the connection to the network can be used for telephone communications, and the operations for the reconnection to the network when the telephone communication ends can be made automatically, so a seamless network connection becomes possible, in which the user is not made to be conscious of the changes between the state of being connected to the network and the state of being disconnected therefrom, or even the changes involving the voice telephone communications means becomes possible.

Additionally, according to the present embodiment, basic software for booting, application software, connection protocols and other such varieties of programs and varieties of data are recorded in the medium, and also, specific data that is necessary for the applications can be stored in a sequentially updateable fashion, whereby a medium in which each application is complete can be provided. Note that it is also possible to include the operating system (OS) among the programs.

Note that the possible types of applications for executing the medium include applications for: (1) connecting to the internet in order to use the medium 200 to display content; (2) connecting to the internet as necessary in order to use the medium 200 as travel information and/or as a travel album; (3) connecting to the internet as necessary in order to use the medium 200 for managing housing information or housing facilities; (4) connecting to the internet as necessary in order to use the medium 200 as a mail order catalog; (5) connecting to the internet as necessary in order to use the medium 200 as an educational system; (6) connecting to the internet as necessary in order to make the medium 200 function as a dictionary; and (7) connecting to the internet as necessary in order to make the medium 200 function for photograph and/or illustration management, for example.

Further, according to the present embodiment, it is possible to record necessary data (such as home page information, search site information, portal information) inside the medium, so the need to connect to the network at booting time in order to display the contents disappears in the case of contents which are not to be updated frequently. Further, according to the present embodiment, it is possible to record in the medium necessary information that is different for each of the medium's purposes, so it is possible to provide a network connection method which is not dependent upon the main body of the computer. Further, according to the present embodiment, it is possible to forward the identical data to a plurality of media via the auxiliary storage medium, so it becomes possible to forward personal information of the user to a plurality of media, for example.

Further, according to the present invention, the information inside the network to which connection has been made is recorded in the medium, so this information is handled in the same way as the other data which was in the medium from the very beginning; therefore, it is possible to display the content before connecting to the network. Further, according to the present embodiment, it is possible to use the portal information locally, so it is possible to provide a configuration for connecting to the network only at a time or times, after loading, when the connection is necessary.

As explained above, the invention achieves an effect that contents can be displayed on a screen quickly and by means of the simple manipulation of setting the removable storage medium, the various applications can be executed, and also, the downloaded data can be stored in the removable storage medium, whereby the downloaded data can be easily managed and the ease of use for the user is improved.

What is claimed is:

1. A network connection method comprising:
a reading process in which at a time when a removable storage medium having a read-only unit for recording, in read-only format, data such as various types of programs, and, a read-capable write-capable unit for reading and writing various types of data, is set in a computer main body in an exchangeable fashion, the data is read from the read-only unit and from the read-capable write-capable unit of the removable storage medium;
a booting process of booting a computer based on a program read from the removable storage medium;
a network connection process of downloading various types of data through a network, based on the program read out from the removable storage medium; and
a writing process of writing to the read-capable write-capable unit the various types of data downloaded through the network.

2. A network connection method according to claim 1, further comprising:
an update determination process of determining whether or not the various types of downloaded data is update data having updated the various types of data already recorded in the read-capable write-capable unit; and
an updating process of updating the recorded data to the various types of downloaded data in the case where the downloaded data is update data.

3. A network connection method according to claim 1, further comprising a displaying process of using data read out from the read-only unit and the read-capable write-capable unit of the removable storage unit in order to display various content before the execution of the network connection process, and also, using various downloaded data in order to display various content after the execution of the network connection method.

4. A network connection method according to claim 1, further comprising an executing process of executing a program after the execution of the network connection process in the case where the various downloaded data is the program.

5. A network connection method according to claim 1, further comprising a booting information comparison process of comparing booting information stored in an auxiliary storage medium provided separately from the removable storage medium, and booting information stored in the removable storage medium; wherein
as a result of the comparison conducted in the booting information comparison process, the booting process is performed based on the booting information recorded in the auxiliary storage medium in the case where the two sets of booting information is identical.

6. A network connection method according to claim 5, wherein as a result of the comparison conducted in the booting information comparison process, the booting process is performed based on the booting information recorded in the removable storage medium in the case where the two sets of booting information are mutually different.

7. A network connection method according to claim 1, further comprising a booting information confirmation process for confirming that booting information is recorded in the removable storage medium; wherein
as a result of the comparison conducted in the booting information confirmation process, the booting process is performed based on the booting information recorded in the auxiliary storage medium in the case where booting information is not recorded in the removable storage medium.

8. A network connection method according to claim 1, further comprising:
a temporary recording process of temporarily recording the various data recorded in the removable storage medium into the auxiliary storage medium provided separately from the removable storage medium; and
a forward-and-record process for forwarding and recording the various information temporarily recorded in the auxiliary storage medium over to a separate removable storage medium.

9. A network connection method according to claim 1, further comprising a disconnecting process of disconnecting the connection to the network after completion of the downloading of the various data in the network connection process.

10. A network connection method according to claim 1, wherein the program execution process to be performed after the execution of the network connection process further comprises:
a connection information saving process of recording connection information to the read-capable write-capable unit of the removable storage medium or to the auxiliary storage medium;
a disconnection process of disconnecting the connection to the network after completion of the connection information saving process; and
a network reconnection process of reconnecting to the network in the same state as that before the disconnection process according to the connection information saved in the connection information saving process after the completion of the program execution process.

11. A network connection method according to claim 10, wherein an application executed in the program execution process is an application using a telephone line.

12. A network connection method according to claim 1, wherein the network is internet, and the network connection method connects to a server having the data to be downloaded via the internet.

13. A network connection method according to claim 12, wherein the various data recorded in the removable storage medium and data of a server are data which are established as a pair by means of data correspondence information stored in the removable storage medium, and the data correspondence information is uploaded in the network connection process, producing a result that the various data being stored in the removable storage medium are linked to the data of the server.

14. A computer readable removable storage medium having a read-only unit for recording, in read-only format, data such as various types of programs, and a read-capable write-capable unit for reading and writing the various types of data, and also, is set in a computer main body in an exchangeable fashion, and stores a program in its read-only unit for making a computer execute a network connection method comprising:
a booting process of booting the computer;
a network connection process of downloading various types of data through a network; and
a writing process of writing to the read-capable write-capable unit the various types of data downloaded through the network.

15. A computer readable removable storage medium according to claim 14, wherein the read-only unit is made of a physical or electrical means for being read only, and the read-capable write-capable unit is made of a physical or electric means capable of being read and written to.

16. A computer readable removable storage medium according to claim 14, wherein at a time when the computer is booted by means of the stored booting information, the read-only unit is defined as an area for being read from only.
